(19) United States
(12) Patent Application Publication
(10) Pub. No.: US 2008/0185395 A1
(43) Pub. Date: Aug. 7, 2008

(54) Dispenser and method

(75) Inventor: Andrew Graham Sahud, Pittsburgh, PA (US)

Correspondence Address: Ansel M. Schwartz;Attorney at Law, Suite 304, 201 N. Craig Street, Pittsburgh, PA, 15213, US

(73) Assignee: Allegheny-Singer Research Institute

(21) Appl. No.: 11/701,130

(22) Filed: Feb. 1, 2007

(51) Int. Cl. B67D 5/22

(52) U.S. Cl. 222/36; 222/38

(57) ABSTRACT

A dispenser for monitoring content in a container which includes a holder for holding the container. The dispenser includes a lever engaged with the holder which when depressed, releases a portion of the content in the container. The depression of the lever is a dispensing event. The dispenser includes a tracker engaged with the lever for keeping track by counting the number of dispensing events. The dispenser includes an indicator in communication with the tracker for indicating how much content is remaining in the container as a function of dispensing events. A method for monitoring content in a container includes the steps of depressing a lever engaged with a housing holding the container which releases a portion of the content in the container, the depression of the lever being a dispensing event. There is the step of tracking with a tracker engaged with the lever the number of dispensing events by counting the number of dispensing events. There is the step of indicating with an indicator in communication with the tracker how much content is remaining in the container as a function of dispensing events.

### FIELD OF THE INVENTION

The present invention is related to monitoring content in a container. More specifically, the present invention is related to monitoring content in a container that has an indicator in communication with a tracker for indicating how much content is remaining in the container as a function of dispensing events.

### BACKGROUND OF THE INVENTION

Liquid soap and alcohol gel wash dispensers are now ubiquitous throughout medical centers in the United States. Unfortunately, these dispensers become empty very quickly and the janitorial staff often needs reminding to refill supplies. An empty dispensing unit is not an excuse to avoid necessary hand hygiene, but having supplies available on a virtually continuous basis is crucial to assuring that hand hygiene compliance is optimized. The current means of detecting whether such devices are empty generally occurs after a health care provider informs the ward clerk or a hospital maintenance worker to replace supplies. Most dispensers have a small see through window on the front of the unit, which presumably is supposed to aid in identifying when these devices are close to being empty. Unfortunately, these windows are essentially purposeless because a) many of the alcohol gel wash products are clear, and thus make it difficult to perceive if supplies are indeed low, and b) colored soaps and washing solutions are also difficult to read from the window device, albeit minimally more effective than clear substances.

The impact of improved hand hygiene compliance is well recognized as the simplest most effective means for limiting the spread of infection both within and outside of the hospital setting. Despite this evidence, hand hygiene compliance rates among health care providers remains approximately 35-40%. There are a variety of initiatives which attempt to improve adherence to these basic policies, and yet, such efforts are often thwarted when dispensing devices are empty for days at a time without being refilled. A large hospital typically has between 400-800 beds. Most hospital rooms have an alcohol gel wash dispensing device just outside or immediately upon entering the patient room. Patient rooms are also obligated to have a sink available with a liquid soap dispenser in proximity to the water supply. Those entering the room have the option of using antibacterial soap or alcohol gel wash before and after each patient encounter. It is easy to understand how a hospital with 500 beds/rooms could have well over 1000 dispensing devices (excluding bathrooms and other settings). The maintenance or janitorial staff understandably has difficulty keeping up with supply and demand. There needs to be a simple method to indicate where supplies are lacking so that this information can be obtained by simply glancing down the hall of a hospital ward. Obviously, such a concept could be employed in other settings such as within the bathroom of a restaurant, public schools, physician offices, and many other venues.

While key producers of soap and cleaning products such as GOJO Industries or Kimberly-Clark have dominated the soap and antibacterial product market, neither has a simple device such as the one detailed above. The concept of this invention is simple, straightforward, and potentially extremely helpful. Currently, hospital rooms have IV pump machines, pulse oximetry devices, telemetry monitors, and other equipment. Many of these products have audible alarms. The alarms are set such that they are very sensitive and have a low threshold for firing. Hence, these alarms are more often a nuisance than an aid. In this setting, a simple light indicator would balance the busy and often noisy hospital ward by helping to keep supplies ready and available for healthcare providers, eliminate the need to call and notify staff to replace supplies, facilitate the burdensome job of the janitorial and maintenance staff, and ultimately would have a favorable impact upon patient care.

### BRIEF SUMMARY OF THE INVENTION

The present invention pertains to a dispenser for monitoring content in a container. The dispenser comprises a holder for holding the container. The dispenser comprises a lever engaged with the holder which when depressed, releases a portion of the content in the container. The depression of the lever is a dispensing event. The dispenser comprises a tracker engaged with the lever for keeping track by counting the number of dispensing events. The dispenser comprises an indicator in communication with the tracker for indicating how much content is remaining in the container as a function of dispensing events.

The present invention pertains to a method for monitoring content in a container. The method comprises the steps of depressing a lever engaged with a housing holding the container which releases a portion of the content in the container, the depression of the lever being a dispensing event. There is the step of tracking with a tracker engaged with the lever the number of dispensing events by counting the number of dispensing events. There is the step of indicating with an indicator in communication with the tracker how much content is remaining in the container as a function of dispensing events.

### BRIEF DESCRIPTION OF THE SEVERAL VIEWS OF THE DRAWING

In the accompanying drawings, the preferred embodiment of the invention and preferred methods of practicing the invention are illustrated in which:

FIG. 1 is a schematic representation of the dispenser of the present invention.

FIG. 2 is a schematic representation of a front view of the dispenser.

FIG. 3 is a schematic representation of a side view of the dispenser.

FIG. 4 shows a front view of the dispenser.

FIG. 5 shows a cross-sectional view of mechanical features of the dispenser.

FIG. 6 shows a side view of the mechanical features.

### DETAILED DESCRIPTION OF THE INVENTION

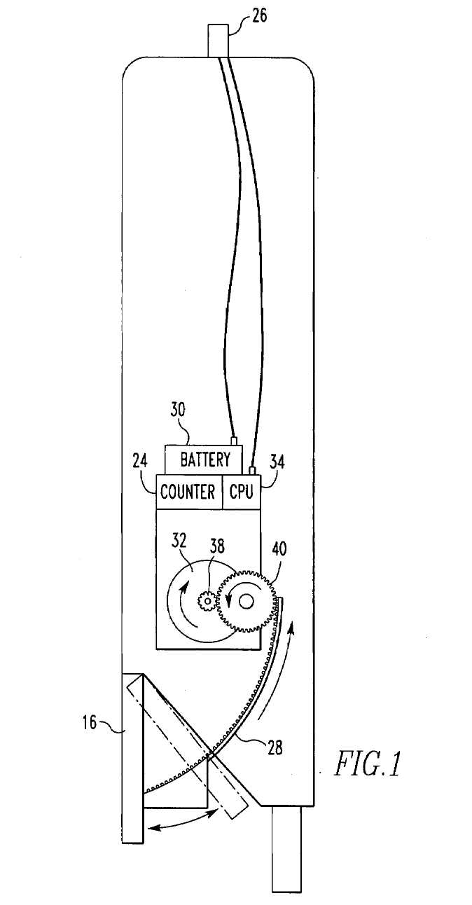

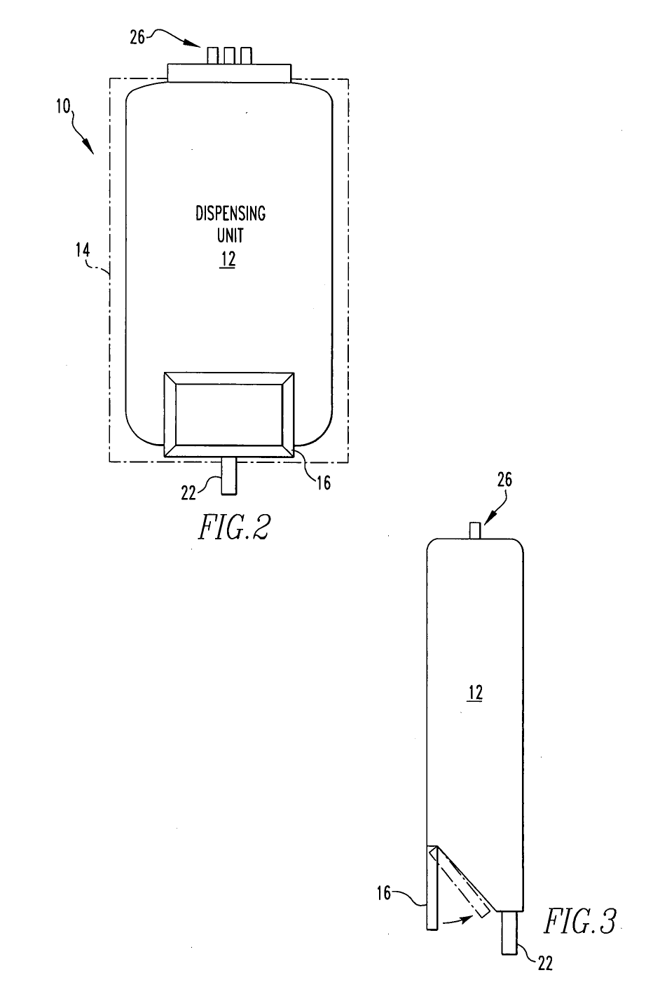

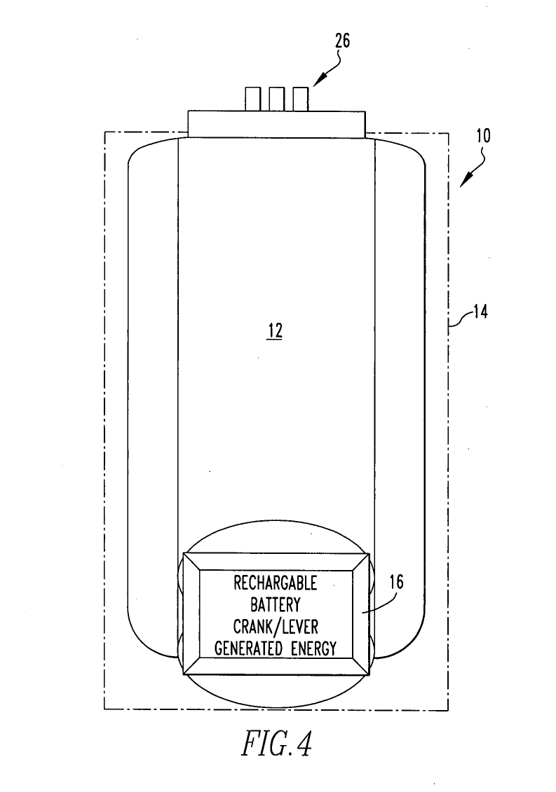

Referring now to the drawings wherein like reference numerals refer to similar or identical parts throughout the several views, and more specifically to FIGS. 1-4 thereof, there is shown a dispenser 10 for content in a container 12. The dispenser 10 comprises a holder 14 for holding the container 12. The dispenser 10 comprises a lever 16 engaged with the holder 14 which when depressed, releases a portion of the content in the container 12. The depression of the lever 16 is a dispensing event. The dispenser 10 comprises a tracker 18 engaged with the lever 16 for keeping track by counting the number of dispensing events. The dispenser 10 comprises an indicator 20 in communication with the tracker 18 for indicating how much content is remaining in the container 12 as a function of dispensing events. The content can be soap.

Preferably, the dispenser 10 includes an outlet port 22 through which the content is released from a container 12.

The tracker 18 preferably includes a counter 24 that counts the dispensing events. Preferably, the indicator 20 includes at least one light 26 that activates after a predetermined number of dispensing events. The tracker 18 preferably includes a track lever 28 with a gear having sprockets and a gear that engages the sprockets, when the lever 16 is moved, the sprockets move the gear. Preferably, the tracker 18 includes an electric counter 24 that is advanced and records each time there is a dispensing event.

The dispenser 10 preferably includes a battery 30 disposed in the housing. Preferably, the dispenser 10 includes a fly wheel 32 engaged with the gear, when the gear moves, the gear causes the fly wheel 32 to spin. The battery 30 preferably is rechargeable, and the fly wheel 32 is disposed in a magnetic field. When the lever 16 is depressed and the gear moves, the fly wheel 32 is caused to spin and generate a current which charges the battery 30. Preferably, the dispenser 10 includes a processor 34 disposed in the housing, and an input device for inputting input to the processor 34. When the housing is opened for the container 12 to be replaced, preferably the light 26 is reset to indicate the container 12 is full of content.

The present invention pertains to a method for monitoring content, such as soap, in a container 12. The method comprises the steps of depressing a lever 16 engaged with a housing holding the container 12 which releases a portion of the content in the container 12, the depression of the lever 16 being a dispensing event. There is the step of tracking with a tracker 18 engaged with the lever 16 the number of dispensing events by counting the number of dispensing events. There is the step of indicating with an indicator 20 in communication with the tracker 18 how much content is remaining in the container 12 as a function of dispensing events.

Preferably, the tracking step includes the step of counting with a counter 24 the dispensing events. The indicating step preferably includes the step of activating at least one light 26 as a predetermined number of dispensing events. Preferably, the tracking step includes the step of moving a track lever 28 when the lever 16 is depressed which has sprockets that engage a gear which moves the gear.

In the operation of the invention, the volume of soap, which is defined herein to a liquid soap or alcohol gel wash or soap powder or soap foam (basically, any cleansing agent) in a dispenser 10 is standardized. Most contain 500 ml of solution, larger items contain 800 ml. Each dispensing event (depressing of a lever 16 on the wall mounted dispensing unit) reduces the supply of solution by approximately 1 ml. Therefore, a 500 ml container 12 would allow for approximately 500 individual uses. A counter 24 can be utilized for each dispensing action in order to keep track of existing liquid supplies. A visual indicator based on light, for instance, having three small LED lights 26 can be placed onto the dispensing device and would serve to inform users and maintenance staff of the status of the washing supply. A green light 26 would remain lit until a majority of solution had been used. In the example of a 500 ml holding dispenser 10, the counter 24 could be set to change from green to yellow once 400 uses had been registered (i.e. 80% of the supplies had been depleted). The yellow light 26 would then remain lit until there were approximately 50 uses remaining. (An audible indication could also be used, where a beep or chirp like that of an alarm with a low battery would be heard.) Maintenance staff would be able to quickly walk through a ward and immediately identify those devices in need of additional supplies before being contacted. This feature would obviate the need to physically test each wall mounted device to see if it was empty. The lighting unit could be powered by a small watch battery 30 unit (likely to last several years) and all three lights 26, green, yellow, and red could blink simultaneously to indicate when battery 30 supplies were indeed low. Alternatively, the device could utilize a crank energy generating mechanism (similar to those used in emergency flashlights or radios) thereby avoiding a dependence on batteries as an external energy source. Each time the dispensing lever 16 is activated, the crank mechanism provides energy to an installed rechargeable battery 30. Alternatively, electric wiring in the building could simply be run to the dispenser to power it.

On each occasion that the dispensing unit is used, the lever 16 is depressed forward to an anterior position of approximately 2-3 cm in order to release washing solution. Once this action takes place, the lever 16 returns to its resting position which is in vertical alignment with the overall structure. (See FIG. 3.) This is standard for existing holders that dispense soap. Such a standard holder is modified with the features described herein added to it to comprise the dispenser 10.

For the purposes of being retrofitted to work with the dispenser 10, the lever 16 would be mechanically connected to a perpendicular track lever 28 with gear sprockets that would engage another round gear, a large gear wheel 40, which is installed within the dispensing unit. With each depression of the lever 16, the gear wheel 40 turns. This turning causes an electronic counter 24 to advance and record the number of individual uses for each device. Additionally, the kinetic energy caused by pressing the soap dispensing lever 16 turns the gear wheel 40 which uses a magnetic field to generate current, as more fully described below. This current is sent electronically to a rechargeable battery 30 inside the unit. The battery 30 is then used to supply energy to the LED lights 26, CPU, and the electronic counting device. (See FIG. 1.)

The maximal number of uses for each dispensing unit (calculated based on the amount dispensed with each use multiplied by the total amount of solution in each bag-total milliliters), would be input via a small key pad inside the device, or preinstalled in dispensers designed with the features described herein. When a dispenser 10 is opened (which is done routinely to replace cleaning solution) and the counter 24 can be manually reset or inspected. A small CPU would send a signal to the LED lights 26 attached to the top of the dispensing unit. A green light would remain lit until 80% of the solution had been used. At 80% of use, the CPU would automatically cause the yellow LED light 26 on top of the dispensing unit to turn on and the green LED light 26 would turn off. At 90% use, the CPU would signal to turn on the red LED light 26 and turn off the yellow LED light 26. Such a system will serve to alert users and maintenance staff when soap or cleaning solution needs replacement.

As such, depressing the lever 16 on the holder 14 would cause three simultaneous events: 1) a standard amount of cleaning solution is dispensed, 2) the electronic counter 24 advances with each use, and 3) the gear wheel 40 inside the device advances where an alternator (utilizing the mechanical/kinetic energy) from the action of dispensing (placed in the context of a magnetic field) would then charge a battery 30.

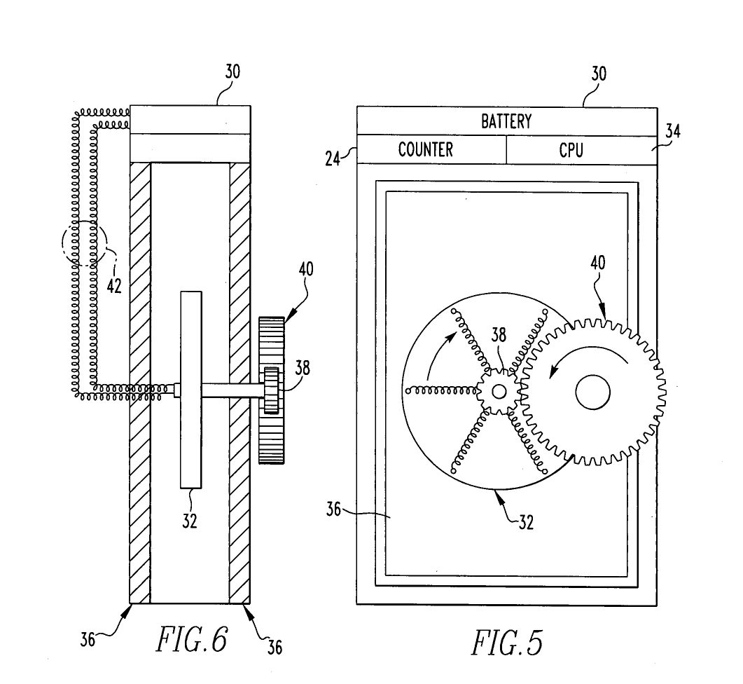

Referring to the FIG. 5, there is a more detailed view of the mechanical features of the dispenser 10. There is a magnet 36 situated on opposing sides of the fly wheel 32. FIG. 5 shows only one magnet 36 situated behind the fly wheel 32. The fly wheel 32, with copper wiring embedded in it, spins within the context of the two parallel magnets 36. A small gear wheel 38 to which the fly wheel 32 is attached has sprockets which is engaged with sprockets of the circular large gear wheel 40. As explained above, the large gear wheel 40 is driven by the track lever 28 with sprockets when the lever is depressed when a dispensing event occurs. Thus, the movement of the track lever 28 against the large gear wheel 40 causes the large gear wheel 40 to turn, which in turn rotates the small gear wheel 38, causing the fly wheel 32 to spin.

FIG. 6 shows a side view of the mechanical features of FIG. 5. Both magnets 36 can be seen on opposing sides of the fly wheel 32. A wire 42 connects the battery 30 and the fly wheel 32 so current from the fly wheel 32 flows to the battery 30. The movement of the small gear wheel 38 with sprockets by the movement of the large gear wheel 40 with sprockets causes the fly wheel 32 to spin within the context of the magnetic field created by both magnets 36 positioned behind and in front of the fly wheel 32, which causes the generation of the current.

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

1. A dispenser for monitoring content in a container comprising:
a holder for holding the container;
a lever engaged with the holder which when depressed, releases a portion of the content in the container, the depression of the lever being a dispensing event;
a tracker engaged with the lever for keeping track by counting the number of dispensing events; and
an indicator in communication with the tracker for indicating how much content is remaining in the container as a function of dispensing events.

2. A dispenser as described in claim 1 including an outlet port through which the content is released from a container.

3. A dispenser as described in claim 2 wherein the tracker includes a counter that counts the dispensing events.

4. A dispenser as described in claim 3 wherein the indicator includes at least one light that activates after a predetermined number of dispensing events.

5. A dispenser as described in claim 4 wherein the tracker includes a track lever with a gear having sprockets and a gear that engages the sprockets, when the lever is moved, the sprockets move the gear.

6. A dispenser as described in claim 5 wherein the tracker includes an electric counter that is advanced and records each time there is a dispensing event.

7. A dispenser as described in claim 6 including a battery disposed in the housing.

8. A dispenser as described in claim 7 including a fly wheel engaged with the gear, when the gear moves, the gear causes the fly wheel to spin.

9. A dispenser as described in claim 8 wherein the battery is rechargeable, and the fly wheel is disposed in a magnetic field, when the lever is depressed and the gear moves, the fly wheel is caused to spin and generate a current which charges the battery.

10. A dispenser as described in claim 9 including a processor disposed in the housing, and an input device for inputting input to the processor.

11. A dispenser as described in claim 10 wherein when the housing is opened for the container to be replaced, the light is reset to indicate the container is full of content.

12. A method for monitoring content in a container comprising the steps of:
depressing a lever engaged with a housing holding the container which releases a portion of the content in the container, the depression of the lever being a dispensing event;
tracking with a tracker engaged with the lever the number of dispensing events by counting the number of dispensing events; and
indicating with an indicator in communication with the tracker how much content is remaining in the container as a function of dispensing events.

13. A method as described in claim 12 wherein the tracking step includes the step of counting with a counter the dispensing events.

14. A method as described in claim 13 wherein the indicating step includes the step of activating at least one light as a predetermined number of dispensing offense.

15. A method as described in claim 14 wherein the tracking step includes the step of moving a track lever when the lever is depressed which has sprockets that engage a gear which moves the gear.

16. A method for monitoring soap in a container comprising the steps of:
depressing a lever engaged with a housing holding the container which releases a portion of the soap in the container, the depression of the lever being a dispensing event;
tracking with a tracker engaged with the lever the number of dispensing events by counting the number of dispensing events; and
indicating with an indicator in communication with the tracker how much soap is remaining in the container as a function of dispensing events.
